(19) United States
(12) Patent Application Publication
(10) Pub. No.: US 2015/0219257 A1
(43) Pub. Date: Aug. 6, 2015

(54) IDENTIFICATION DEVICE ATTACHMENTS FOR PNEUMATIC DEVICES

(71) Applicant: STANLEY BLACK & DECKER, INC., New Britain, CT (US)

(72) Inventors: Lawrence E. Harper, Marietta, GA (US); William Edward Gatling, Acworth, GA (US)

(21) Appl. No.: 14/421,332

(22) PCT Filed: Aug. 14, 2013
(86) PCT No.: PCT/US2013/054871

§ 371 Date: Feb. 12, 2015

Related U.S. Application Data
(60) Provisional application No. 61/682,981, filed on Aug. 14, 2012.

(51) Int. Cl. F16L 25/00; F16L 15/00; F16L 37/00; B25F 5/00

(52) U.S. Cl. CPC F16L 25/00; B25F 5/00; F16L 15/00; F16L 37/00

(57) ABSTRACT

Disclosed are various embodiments for attaching an electronic identification device to a pneumatic device. A coupling assembly is configured to couple a first pneumatic device to a second pneumatic device. The coupling assembly comprises an adapter body that has a passed for a compressed fluid to flow from the second pneumatic device to the first pneumatic device. The adapter body further comprises a first connector that is configured to attach to the first pneumatic device. The adapter body further comprises a second connector that is configured to attach to the second pneumatic device. An electronic device is configured to be attached to the adapter body and to transmit an identification signal.

### BACKGROUND

A Radio Frequency Identification (RFID) tag is a type of electronic identification device that may be used to identify and track various objects. In practice, an RFID tag may be attached to an object, and an RFID reader may sense the presence of and identifying information associated with the RFID tag. The RFID reader may be located at an entrance or exit of an environment to facilitate the tracking and identification of RFID-enabled objects that enter or exit the environment. By being able to track RFID-enabled objects, it is less likely that these objects become misplaced.

RFID tags may be added to existing objects. To this end, an RFID tag may be mounted directly to the exterior of an object using adhesives or shrink-wrap. However, it may be impractical to use adhesives or shrink-wrap to mount an RFID tag to, for example, a portable power tool. In many cases, an RFID tag mounted directly to the exterior of the portable power tool may prevent the power tool from accessing a workpiece. Additionally, gluing or shrink-wrapping an RFID tag to the exterior of a portable power tool may interfere with a user holding or manipulating the portable power tool.

In order to overcome these obstacles, an object may be manufactured to incorporate an RFID tag. However, it may be expensive to replace existing objects with new RFID-enabled objects. For example, portable power tools may be relatively expensive, and a mechanic shop may have several different portable power tools. Replacing an existing inventory of portable power tools with RFID-enabled power tools may be expensive and impractical.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a coupling assembly attached to a pneumatic device according to various embodiments of the present disclosure.

FIG. 2 is a drawing of the components of the coupling assembly of FIG. 1 according to various embodiments of the present disclosure.

FIGS. 3A-3B are drawings of a core for the coupling assembly of FIG. 2 according to various embodiments of the present disclosure.

FIGS. 4A-4B are drawings of a cover for the coupling assembly of FIG. 2 according to various embodiments of the present disclosure.

FIGS. 5A-5B are drawings of a pad for the coupling assembly of FIG. 2 according to various embodiments of the present disclosure.

FIGS. 6A-6B are drawings of the coupling assembly of FIG. 2 according to various embodiments of the present disclosure.

FIG. 7 is a flowchart representing an example of a portion of the functionality performed in association with the coupling assembly of FIG. 2 according to various embodiments of the present disclosure.

### DETAILED DESCRIPTION

The present disclosure is directed towards attaching an electronic identification device, such as an RFID tag, to a pneumatic device. Such a pneumatic device may be, for example, an impact wrench, a drill, a nailer, a stapler, a sander, a saw, a grinder, an air compressor, a hose, or any other type of device that uses, generates, and/or channels a compressed fluid. With an electronic identification device attached to a pneumatic device, the pneumatic device may be identified and/or tracked using a suitable receiver device, such as an RFID reader.

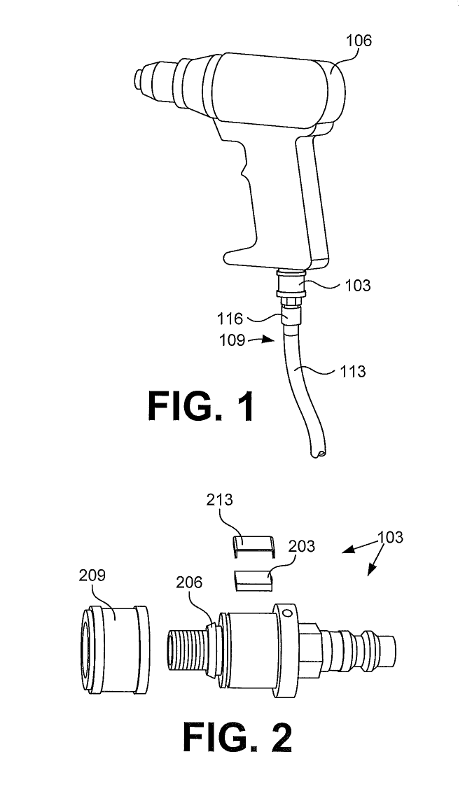

With reference to FIG. 1, shown is an example of a coupling assembly 103 according to various embodiments of the present disclosure. The coupling assembly 103 in the embodiment shown in FIG. 1 couples a pneumatic tool 106 to a hose 109. In alternative embodiments, the coupling assembly 103 may couple other types of pneumatic devices. As a non-limiting example, the coupling assembly 103 may couple the hose 109 to another hose 109. As a further non-limiting example, the coupling assembly 103 may couple a compressor to the hose 109 and/or any other suitable component that operates in a pneumatic system.

The pneumatic tool 106 may be a device that is powered by a compressed fluid, such compressed air or any other suitable fluid. The pneumatic tool 106 shown in FIG. 1 is embodied in the form of an impact wrench. Although the pneumatic tool 106 shown in FIG. 1 is an impact wrench, it is understood that the pneumatic tool 106 in alternative embodiments may be various types of devices. As non-limiting examples, a pneumatic tool 106 may be embodied in the form of an impact wrench, a drill, a nailer, a stapler, a sander, a saw, a grinder, or any other type of tool that is driven by a compressed fluid.

The hose 109 may be a pneumatic device that channels the compressed fluid between other pneumatic devices. The hose 109 shown in FIG. 1 channels the compressed fluid from a compressor to the pneumatic tool 106. To this end, the hose 109 may comprise a flexible tube 113, a hose connector 116, and/or other components. The hose connector 116 facilitates connecting the hose 109 to the coupling assembly 103. As non-limiting examples, the hose connector 116 may comprise a “quick connect” coupling or a threaded nipple that facilitates connecting the hose 109 to the coupling assembly 103.

With reference to FIG. 2, shown is an exploded view of the coupling assembly 103 according to various embodiments of the present disclosure. The coupling assembly 103 may comprise, for example, an electronic identification device 203, an adapter body 206, a cover 209, a pad 213, and/or other components. As will be described in more detail below, the coupling assembly 103 may facilitate coupling a first pneumatic device, such as the pneumatic tool 106 to a second pneumatic device, such as the hose 109.

The electronic identification device 203 may emit an identification signal that is capable of being received by an appropriate reader. The identification signal may include data that uniquely corresponds to the electronic identification device 203 with respect to other electronic identification devices 203, thereby facilitating the identification of the electronic identification device 203 and/or the components to which it is attached. The electronic identification device 203 may be active, semi-active, or passive and may or may not include programmable storage memory. In various embodiments, the electronic identification device 203 may be embodied in the form of an RFID tag or any other suitable type of device that may be capable of emitting an identification signal.

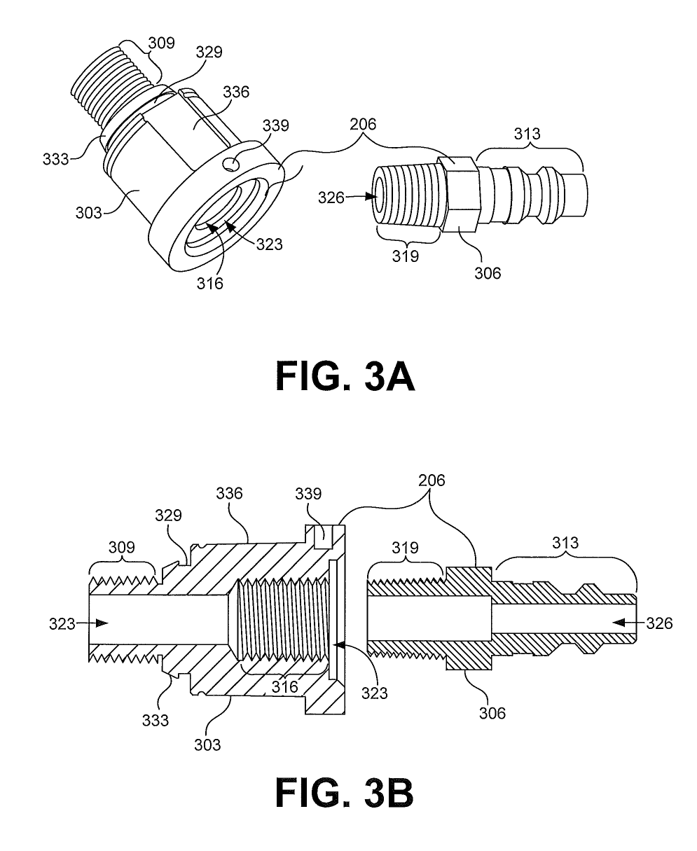

With reference to FIGS. 3A-3B, shown are drawings of the adapter body 206 according to various embodiments of the present disclosure. In particular, FIG. 3A shows a perspective view of the adapter body 206 disassembled, and FIG. 3B shows a cross-section of the adapter body 206 disassembled.

The adapter body 206 in the embodiment shown in FIGS. 3A-3B comprises a first portion 303 and a second portion 306 that are joined together when the adapter body 206 is assembled. In alternative embodiments, the adapter body 206 may be embodied as a single component. In this regard, the adapter body 206 may be formed from a single non-detachable piece.

For the embodiment shown in FIGS. 3A-3B, the first portion 303 of the adapter body 206 comprises a first connector 309, and the second portion 306 of the adapter body 206 comprises a second connector 313. The first connector 309 is configured to connect to a corresponding connector of a pneumatic device, such as the pneumatic tool 106. For the adapter body 206 shown in FIGS. 3A-3B, the first connector 309 is embodied as a threaded male nipple. In this regard, the first connector 309 shown in FIGS. 3A-3B comprises external threads that are configured to be received by a corresponding threaded receptacle in the pneumatic tool 106.

The second connector 313 is configured to connect to a corresponding connector of a pneumatic device, such as the hose connector 116 of the hose 109. For the adapter body 206 shown in FIGS. 3A-3B, the second connector 313 is embodied as a male quick connect coupling. In this regard, the second connector 313 shown in FIGS. 3A-3B is configured to insert into a corresponding female quick connect coupling that facilitates attachment and detachment by, for example, a slidable quick connect sleeve on the female quick connect coupling.

The first portion 303 of the adapter body 206 may also comprise a third connector 316, and the second portion 306 of the adapter body 206 may comprise a fourth connector 319. In the embodiment shown in FIGS. 3A-3B, the third connector 316 is embodied as a threaded receptacle, and the fourth connector 319 is embodied as a male threaded nipple. As such, the fourth connector 319 may insert into the third connector 316 and be tightened to thereby attach the first portion 303 of the adapter body 206 to the second portion 306 of the adapter body 206. In alternative embodiments, the first portion 303 may comprise a male threaded nipple, and the second portion 306 may comprise a threaded receptacle to facilitate the first portion 303 being attached to the second portion 306 of the adapter body 206.

The first portion 303 of the adapter body 206 may comprise a first passage 323 that extends from the first connector 309 to the third connector 316. Similarly, the second portion 306 of the adapter body 206 may comprise a second passage 326 that extends from the second connector 313 to the fourth connector 319. Thus, when the first portion 303 and the second portion 306 of the adapter body 206 have been assembled, the first passage 323 and the second passage 326 may be aligned to form a passage that facilitates compressed fluids flowing through the adapter body 206.

The adapter body 206 in various embodiments may also comprise a groove 329, a tapered ring 333, an electronic identification device receptacle 336, a hole 339 and/or potentially other components. The groove 329 may be a recessed portion of the adapter body 206 that is configured to receive a portion of the cover 209. In the embodiment shown in FIGS. 3A-3B, the groove 329 is a continuously annular recess in the first portion 303 of the adapter body 206. In alternative embodiments, the groove 329 may or may not be continuously annular.

The tapered ring 333 may be a portion of the adapter body 206 that facilitates the cover 209 being attached to the adapter body 206. Additionally, the tapered ring 333 may restrict the cover 209 once the cover 209 is in an installed position so that the cover 209 may be restricted from moving with respect to the adapter body 206. To this end, the portion of the tapered ring 333 that is proximate to the first connector 309 may have a diameter that is less than the diameter of the portion that is proximate to the groove 329.

The electronic identification device receptacle 336 may be, for example, a recessed portion of the adapter body 206 where the electronic identification device 203 is configured to be attached. The hole 339 may be, for example, a receptacle that is configured to receive a pin of a spanner wrench or other type of tool that may tighten and loosen the adapter body 206. For example, the pin of a spanner wrench may insert into the hole 339, and the spanner wrench may be turned. Because the pin of the spanner wrench may be in the hole 339 of the adapter body 206, the spanner wrench may rotate the adapter body 206 to thereby tighten or loosen the adapter body 206 with respect to another component.

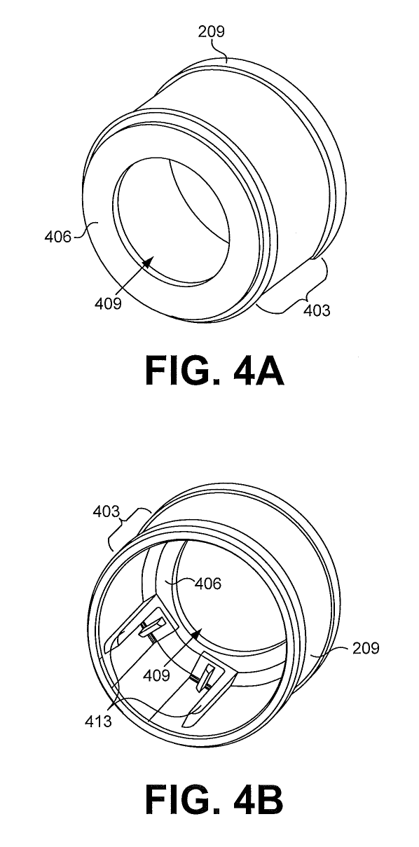

With reference to FIGS. 4A-4B, shown is an example of the cover 209 according to various embodiments of the present disclosure. In particular, FIGS. 4A-4B show perspective views of the cover 209. The cover 209 may comprise, for example, a sleeve 403, a lip 406, and/or other components. Additionally, the lip 406 may form an opening 409 through which a portion of the adapter body 206 may be inserted.

The sleeve 403 may be a portion of the cover 209 that is configured to be positioned over at least a portion of the adapter body 206 and/or the electronic identification device 203. The sleeve 403 may also attach the electronic identification device 203 to the adapter body 206 to, for example, protect the electronic identification device 203 from damage due to mechanical impact and/or other forces. As such, the sleeve 403 and/or other portions of the cover 209 may be constructed of a material through which identifying signals transmitted by the electronic identification device 203 may pass. In this regard, the attenuation of the electronic identification device 203 due to the sleeve 403 and/or other portions of the cover 209 may not prevent a receiving device, such as an RFID reader, from receiving the identifying signals. To this end, the sleeve 403 and/or other portions of the cover 209 may be constructed of nylon and/or or any other suitable material. The sleeve 403 in the embodiment shown in FIGS. 4A-4B is embodied as a tube.

In the embodiment shown in FIGS. 4A-4B, one or more electronic identification device holders 413 (not visible in FIG. 4A) may be formed on the interior wall of the sleeve 403. The electronic identification device holder 413 may provide a space in which the electronic identification device 203 can be positioned when the coupling assembly 103 has been assembled. In various embodiments, the electronic identification device holder 413 may comprise protrusions that extend from the interior wall of the sleeve 403 to form the space in which the electronic identification device 203 can be positioned.

The lip 406 may be a portion of the cover 209 that is configured to be inserted into the groove 329 of the adapter body 206. To this end, the lip 406 may be a portion of the cover 209 that extends radially inward from the sleeve 403. Additionally, the lip 406 may form the opening 409. The first connector 309 and the tapered ring 333 may be inserted through the opening 409 so that the lip 406 may be inserted into the groove 329 in the adapter body 206.

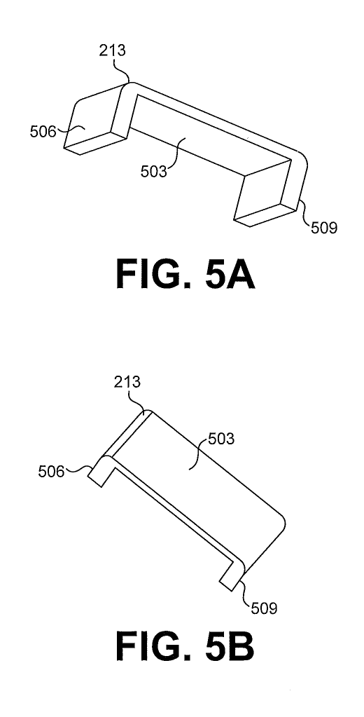

With reference to FIGS. 5A-5B, shown is an example of the pad 213 according to various embodiments of the present disclosure. In particular, FIGS. 5A-5B show perspective views of an example of the pad 213. The pad 213 in various embodiments may provide cushion to, for example, protect the electronic identification device 203 by dampening the force of mechanical impacts to which the electronic identification device 203 may otherwise be subjected.

To reduce the force of mechanical impacts, the pad 213 in various embodiments may be constructed of, for example, foam, rubber, and/or any other suitable material that can absorb and/or dissipate forces from mechanical impacts. The pad 213 in the embodiment shown in FIGS. 5A-5B may comprise, for example, a first wall 503, a second wall 506, a third wall 509, and/or other components. The first wall 503 may extend between the second wall 506 and the third wall 509, and the second wall 506 and the third wall 509 may extend from the first wall 503. When the coupling assembly 103 has been assembled, the electronic identification device 203 may be positioned against the first wall 503 and between the second wall 506 and the third wall 509.

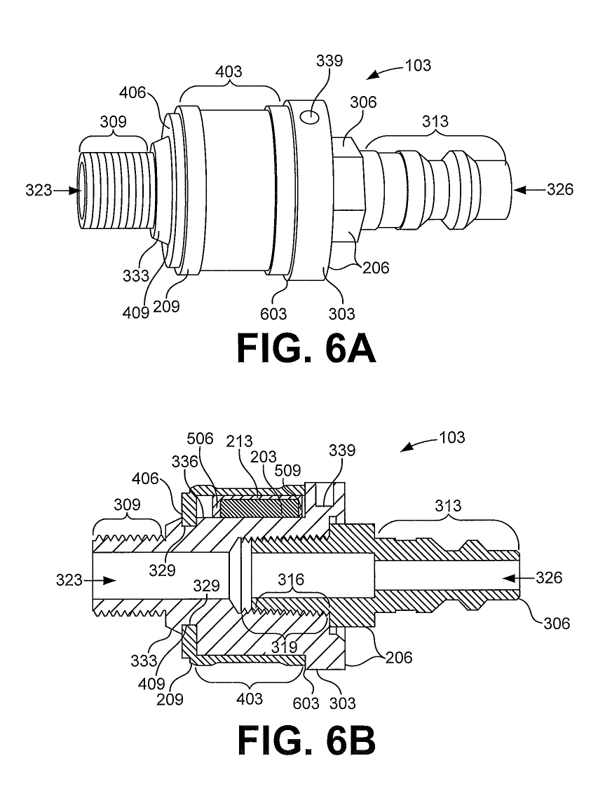

With reference to FIGS. 6A-6B, shown is an example of the coupling assembly 103 after its components have been assembled. In particular, FIG. 6A shows a perspective view of the coupling assembly 103, and FIG. 6B shows a cross-section of the coupling assembly 103.

As shown, the first portion 303 of the adapter body 206 has been attached to the second portion 306 of the adapter body 206. To this end, the third connector 316 (not visible in FIG. 6A) of the second portion 306 has been inserted into the fourth connector 319 (not visible in FIG. 6A) of the first portion 303, and the first portion 303 and the second portion 306 have been tightened with respect to each other. To tighten the first portion 303 with respect to the second portion 306, the pin of the spanner wrench may be inserted into the hole 339, and the spanner wrench may grip and rotate the first portion 303 with respect to the second portion 306.

The electronic identification device 203 may then be positioned in the electronic identification device receptacle 336 in the adapter body 206. In some embodiments, the electronic identification device 203 may be attached to the adapter body 206 using, for example, an adhesive and/or any other suitable mechanism.

With the electronic identification device 203 positioned in the electronic identification device receptacle 336, the pad 213 may be positioned over the electronic identification device receptacle 336. In various embodiments, the pad 213 may be attached to the electronic identification device 203 and/or the adapter body 206 using, for example, an adhesive and/or any other suitable mechanism.

With the electronic identification device 203 positioned on the electronic identification device receptacle 336 and the pad 213 positioned over the electronic identification device 203, the cover 209 may be attached to the adapter body 206. To this end, first connector 309 of the adapter body 206 may be inserted into the opening 409 of the cover 209 so that the sleeve 403 slides over the pad 213 and the electronic identification device 203. After the first connector 309 has been inserted through the opening 409 in the cover 209, the tapered ring 333 may be inserted into the opening 409 so that the lip 406 inserts into the groove 329 in the adapter body 206. In this position, the end of the sleeve 403 that is distal to the lip 406 may contact a rim 603 of the adapter body 206. Additionally, the tapered ring 333 may restrict the lip 406 of the cover 209 from moving out of the groove 329. As a result, the cover 209 may be restricted from being removed from the adapter body 206. Additionally or alternatively, an adhesive and/or other type of mechanism may be used to restrict the cover 209 from being removed from the adapter body 206.

After being assembled, the coupling assembly 103 may be attached to one or more pneumatic devices. For example, the second connector 313 may be attached to the hose 109. In the embodiment shown in FIGS. 6A-6B, the second connector 313 may be inserted into and retained by a female quick connect coupling. Additionally, the coupling assembly 103 may be attached to, for example, the pneumatic tool 106. To this end, the first connector 309 may be inserted into a corresponding connector in the pneumatic tool 106, and a spanner wrench can be used to tighten the coupling assembly 103 to the pneumatic tool 106. Thus, the coupling assembly 103 may couple the pneumatic tool 106 to the hose 109. Additionally, the identification signal that may be transmitted by the electronic identification device 203 may be used to identify the coupling assembly 103 and/or the one or more pneumatic devices to which it is attached.

In some embodiments, the coupling assembly 103 may be restricted from being removed from a pneumatic device, such as the pneumatic tool 106. For example, a thread-locking compound may be applied to the first connector 309. The thread-locking compound may restrict the coupling assembly 103 from being removed from the pneumatic device to which it is attached.

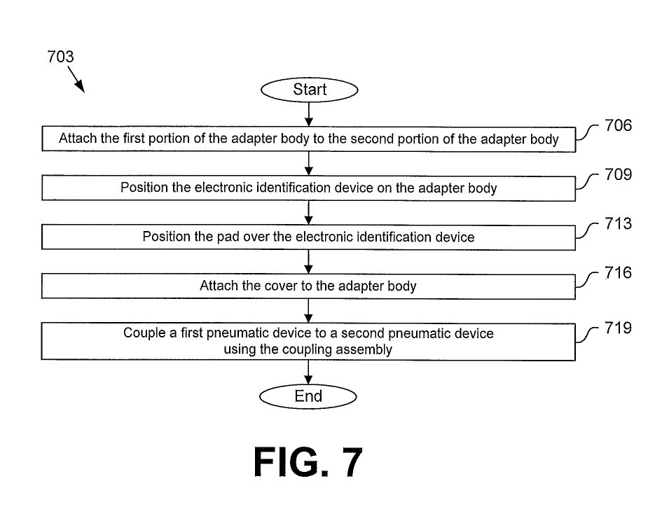

Referring next to FIG. 7, shown is a flowchart 703 that provides one example of the operation of the coupling assembly 103 according to various embodiments. It is understood that the flowchart of FIG. 7 provides merely an example, among others, of the operation of the coupling assembly 103. Although the flowchart 703 shows a specific order of performance, it is understood that the order of performance may differ from that which is depicted. For example, the order of performance of two or more boxes may be scrambled relative to the order shown. Also, two or more boxes shown in succession in the flowchart 703 may be performed concurrently or with partial concurrence. Further, in some embodiments, one or more of the boxes shown in the flowchart 703 may be skipped or omitted.

Beginning with box 706, the first portion 303 of the adapter body 206 is attached to the second portion 306 of the adapter body 206. To this end, the third connector 316 of the second portion 306 and the fourth connector 319 of the first portion 303 may be attached and tightened with respect to each other.

As shown at box 709, the electronic identification device 203 may then be positioned on the adapter body 206. For example, various embodiments of the adapter body 206 may comprise an electronic identification device receptacle 336 in which the electronic identification device 203 is configured to be positioned. Additionally, the electronic identification device 203 may be attached to the adapter body 206 using, for example, an adhesive and/or another type of fastening mechanism. The pad 213 may then be positioned over the electronic identification device 203, as shown at box 713. In various embodiments, an adhesive and/or other type of fastening mechanism may be used to attach the pad 213 to the electronic identification device 203 and/or the adapter body 206.

As indicated at box 716, the cover 209 may then be attached to the adapter body 206. For example, the first connector 309 may be inserted into the opening 409 of the cover 209 so that the sleeve 403 slides over the electronic identification device 203 and the pad 213. Additionally, tapered ring 333 may insert through the opening 409 of the cover 209 so that the lip 406 of the cover 209 inserts into the groove 329 in the adapter body 206. In this position, the tapered ring 333 may restrict the cover 209 from being detached from the adapter body 206.

As shown at body 719, the coupling assembly 103 may then be attached to a first pneumatic device, such as the hose 109, and/or a second pneumatic device, such as the pneumatic tool 106. Thereafter the process ends.

Thus, the coupling assembly 103 may couple two or more pneumatic devices. Additionally, the electronic identification device 203 may transmit an identifying signal that can be used to identify and/or track the coupling assembly 103 and/or one or more of the pneumatic devices to which it is attached.

It is emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a pneumatic tool;
a hose that provides a compressed fluid to power the pneumatic tool; and
a coupling assembly that couples the hose to the pneumatic tool, the coupling assembly comprising:
an adapter body having a passage through which the compressed fluid flows, the adapter body comprising a first connector that is attached to the pneumatic tool, the adapter body further comprising a second connector that is attached to the hose; and
an electronic identification device attached to the adapter body, wherein the electronic identification device transmits an identification signal.

2. The system of claim 1, wherein the adapter body further comprises:
a first portion that comprises the first connector and a third connector; and
a second portion that comprises the second connector and a fourth connector;
wherein the third connector of the first portion of the adapter body is coupled to the fourth connector of the second portion of the adapter body to form the passage through which the compressed fluid flows.

3. The system of claim 1, wherein the first connector of the adapter body comprises a threaded nipple that is insertable into the pneumatic tool.

4. The system of claim 1, wherein the second connector of the adapter body comprises a quick-connect coupling that is attached to a corresponding quick-connect coupling on the hose.

5. The system of claim 1, wherein:
the coupling assembly further comprises a cover that is attached to the adapter body; and
the electronic identification device is positioned between the adapter body and the cover.

6. The system of claim 5, wherein the cover comprises a lip that is inserted into a groove in the adapter body to restrict a removal of the cover from the adapter body.

7. The system of claim 5, wherein the coupling assembly further comprises a pad positioned between the electronic identification device and the cover.

8. The system of claim 7, wherein the pad comprises at least one of a foam or a rubber.

9. An apparatus, comprising:
a coupling assembly configured to couple a first pneumatic device to a second pneumatic device, the coupling assembly comprising:
an adapter body having a passage for a compressed fluid to flow from the second pneumatic device to the first pneumatic device, the adapter body comprising a first connector that is configured to attach to the first pneumatic device, the adapter body further comprising a second connector that is configured to attach to the second pneumatic device; and
an electronic identification device configured to be attached to the adapter body, the electronic identification device being configured to transmit an identification signal.

10. The apparatus of claim 9, wherein:
the coupling assembly further comprises a cover that is configured to be attached the adapter body; and
the electronic identification device is configured to be positioned between the adapter body and the cover.

11. The apparatus of claim 10, wherein:
the cover comprises a sleeve; and
the electronic identification device is configured to transmit the identification signal through the sleeve.

12. The apparatus of claim 10, wherein:
the cover comprises a lip; and
the adapter body comprises a tapered ring that is configured to facilitate insertion of the lip into a groove in the adapter body.

13. The apparatus of claim 10, wherein the cover comprises a holder for the electronic identification device.

14. The apparatus of claim 12, wherein the tapered ring restricts the cover from being removed from the adapter body.

15. The apparatus of claim 9, wherein:
the adapter body comprises:
a first portion comprising a threaded receptacle; and
a second portion comprising a threaded nipple that is attached to the threaded receptacle.

16. The apparatus of claim 9, wherein the adapter body comprises a threaded nipple that is configured to attach the adapter body to the first pneumatic device.

17. The apparatus of claim 9, wherein the adapter body comprises a quick connect coupling that is configured to attach the adapter body to the second pneumatic device.

18. A method, comprising:
attaching an electronic identification device to an adapter body, the electronic identification device being configured to transmit an identification signal;
attaching a first connector of the adapter body to a first pneumatic device; and
attaching a second connector of the adapter body to a second pneumatic device to couple the first pneumatic device to the second pneumatic device; wherein
the adapter body is configured to provide a compressed fluid from the second pneumatic device to the first pneumatic device through a passage in the adapter body.

19. The method of claim 18, further comprising attaching a cover for the electronic identification device to the adapter body.

20. The method of claim 19, further comprising moving a lip of the cover over a tapered ring of the adapter body to insert the lip into a groove in the adapter body.
